(19) United States
(12) Patent Application Publication
(10) Pub. No.: US 2003/0208753 A1
(43) Pub. Date: Nov. 6, 2003

(54) Method, system, and display apparatus for encrypted cinema

(75) Inventors: Robert W. Corrigan, Los Altos, CA (US); Paul A. Alioshin, San Francisco, CA (US)

Correspondence Address: HAVERSTOCK & OWENS LLP, 162 NORTH WOLFE ROAD, SUNNYVALE, CA, 94086, US

(73) Assignee: Silicon Light Machines

(21) Appl. No.: 09/832,738

(22) Filed: Apr. 10, 2001

(51) Int. Cl. H04N 7/167; H04L 9/00

(52) U.S. Cl. 725/31; 380/205; 380/210; 380/282

(57) ABSTRACT

A method, system, and display apparatus, for securely transmitting and displaying visual data, are disclosed. The method of securely transmitting and displaying the visual data includes encrypting the visual data, transporting encrypted visual data to a display apparatus, decrypting the encrypted visual data within the display apparatus, and displaying the visual data as a visual image. The step of decrypting the visual data includes maintaining an electronic version of the visual data within circuit elements that are substantially inaccessible. The system for securely transmitting and displaying the visual data includes an encryption apparatus, means for transporting the encrypted visual data, and the display apparatus. The display apparatus includes circuit elements that are substantially inaccessible. The circuit elements include a decryption circuit for decrypting the encrypted visual data, which forms the visual data within the display apparatus. The circuit elements also include a display circuit for displaying the visual data as a visual image. The circuit elements are configured such that an electronic version of the visual data is maintained within the circuit elements.

### FIELD OF THE INVENTION

This invention relates to the field of displaying digital visual information. More particularly, this invention relates to the field of displaying digital visual information in a way that impedes unauthorized copying.

### BACKGROUND OF THE INVENTION

A film industry includes exhibitors, distributors, and producers of films. In the film industry, the distributors and the producers are each sometimes referred to as studios. Sometimes, a specific producer of a specific film is also the distributor of the specific film. The exhibitors make arrangements with the distributors or the producers to show the films to audiences in return for a percentage of ticket sales and other considerations. Unauthorized exhibition of the films results in lost revenue for the exhibitors, the distributors, and the producers of the films.

In the film industry, a master print of a particular film is kept by the studio. The studio copies the master print to produce a working print. The studio copies the working print, at a studio controlled facility, to make release prints. The release prints are distributed to the exhibitors. Each of the release prints costs several thousand dollars to copy, ship, and insure. Each release print is heavy and bulky, which exacerbates shipping costs.

There are several places where an unauthorized copy of the particular film can be made. An employee at the studio controlled facility can copy the working print to produce the unauthorized copy. A shipping company can lose control of a release print, which is diverted so that the unauthorized copy can be made. An exhibitor employee can make the unauthorized copy. A person can use a video camera at an exhibition to make the unauthorized copy. Once the unauthorized copy is made, a black market enterprise exhibits the particular film or sells video copies of the particular film. The black market enterprise results in lost revenue for the studios and the exhibitors.

A number of copy protection methods have been proposed to impede making of the unauthorized copy. In a first copy protection method, a watermark is encoded into the working copy or the release print to provide clues to whether the unauthorized copy was made from the working copy or from a specific release print. In a second copy protection method, infrared marks are included in the release print so that the video camera is unable to copy the particular film during the exhibition.

Recently, interest has developed in electronic cinema, which distributes a film as digital data. A method of the electronic cinema includes converting a film to the digital data, transporting the digital data to an exhibition facility, and displaying the digital data using a digital projector.

What is needed is a method, system, and display apparatus for the electronic cinema that impedes unauthorized copying of the digital data.

### SUMMARY OF THE INVENTION

The present invention is a method, system, and display apparatus for securely transmitting and displaying visual data. The method of securely transmitting and displaying the visual data includes encrypting the visual data, transporting encrypted visual data to a display apparatus, decrypting the encrypted visual data within the display apparatus, and displaying the visual data as a visual image. The step of decrypting the visual data includes maintaining an electronic version of the visual data within circuit elements that are substantially inaccessible.

The system for securely transmitting and displaying the visual data includes an encryption apparatus, means for transporting the encrypted visual data, and the display apparatus. The display apparatus includes circuit elements that are substantially inaccessible. The circuit elements include a decryption circuit for decrypting the encrypted visual data, which forms the visual data within the display apparatus. The circuit elements also include a display circuit for displaying the visual data as a visual image. The circuit elements are configured such that an electronic version of the visual data is maintained within the circuit elements.

### BRIEF DESCRIPTION OF THE DRAWINGS

FIG. 1 illustrates the preferred electronic cinema system of the present invention.

FIG. 2 illustrates the preferred asymmetric key method of the present invention.

FIG. 3 illustrates display electronics of the present invention.

FIG. 4 illustrates an isometric view of a portion of an alternative Grating Light Valve (GLV) of the present invention.

FIG. 5 illustrates a first cross section of the alternative GLV of the present invention in a reflective state.

FIG. 6 illustrates the first cross section of the alternative GLV of the present invention in a diffractive state.

FIG. 7 illustrates a second cross section of the preferred GLV of the present invention in the reflective state.

FIG. 8 illustrates the second cross section of the preferred GLV of the present invention in the diffractive state.

FIG. 9 illustrates a display integrated circuit of the present invention.

FIG. 10A illustrates a plan view of a display apparatus of the present invention.

FIG. 10B illustrates an unfolded elevation view of the display apparatus of the present invention.

### DETAILED DESCRIPTION OF THE PREFERRED EMBODIMENT

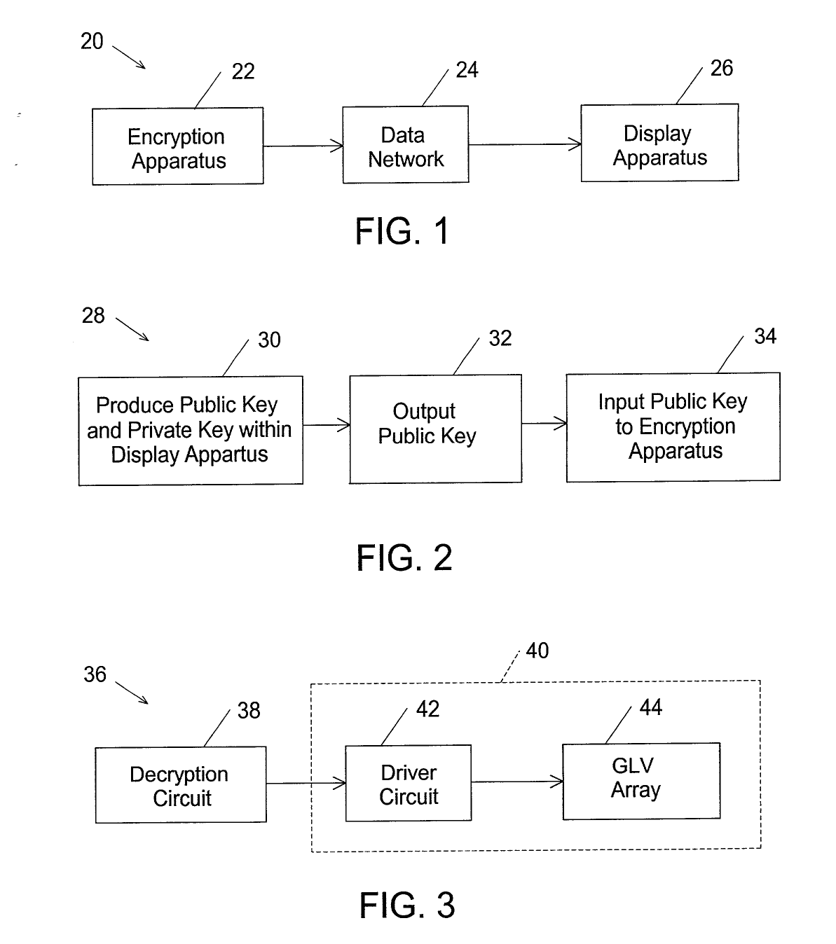

The preferred electronic cinema system of the present invention is illustrated in FIG. 1. The preferred electronic cinema system 20 includes an encryption apparatus 22, a data network 24, and a display apparatus 26. Preferably, a master film at a studio is used to produce a master digital reproduction. Alternatively, the master digital reproduction is a direct result of a film production process using electronic generated imagery.

Preferably, the master digital reproduction is compressed to form a compressed digital reproduction using a lossy compression method. Alternatively, the master digital reproduction is not compressed.

The compressed digital reproduction is entered to the encryption apparatus 22, which in turns produces an encrypted digital reproduction. Preferably, the compressed digital reproduction includes visual data and sound data so that the encrypted digital reproduction includes encrypted visual data and encrypted sound data. Alternatively, the compressed digital reproduction only includes the visual data so that the encrypted digital reproduction includes only the encrypted visual data.

The data network 24 transports the encrypted digital reproduction to the display apparatus 26. The data network 24 is any type of computer data network suitable for transmitting the encrypted digital reproduction including an optical network, a satellite transmission network, or an internet type network.

In the electronic cinema system 20, the encryption apparatus 22 preferably uses a public key to encrypt the compressed digital reproduction in order to produce the encrypted digital reproduction. A public key is part of an asymmetric encryption method. In the asymmetric encryption method, a public key is used to encrypt the compressed digital reproduction and a private key is used to decrypt the encrypted digital reproduction. Thus, the public key is used to encrypt the visual data and the private key is used to decrypt the encrypted visual data.

The preferred asymmetric key method of the present invention is illustrated in FIG. 2. The preferred asymmetric key method 28 includes a key production step 30, a public key output step 32, and a public key input step 31. The key production step 30 uses an algorithm to produce the public key and the private key. The key production step 30 is well known in the art of encryption. Preferably, the display apparatus 26 performs the key production step 30 and the public key output step 32. In this way the private key does not leave the display apparatus 26. Once the public key is available from the public key output step 32, the public key is input to the encryption apparatus 22. Preferably, the display apparatus 26 is designed so that the private key is not accessible from outside the display apparatus 26.

Display electronics of the present invention are illustrated in FIG. 3. The display electronics 36 includes a decryption integrated circuit 38 and a display integrated circuit 40. The display electronics 36 form a portion of the display apparatus 26. The display circuit 40 includes a driver circuit 42 and a Grating Light Valve (GLV) 44. The decryption circuit 38 is coupled to the driver circuit 42 of the display circuit 40. The driver circuit 42 is coupled to the GLV 44.

Preferably, the decryption integrated circuit 38 and the display integrated circuit 40 are separate integrated circuits. In operation, the decryption integrated circuit 38 receives the encrypted digital reproduction and decrypts the encrypted digital reproduction using the private key. Thus, the decryption circuit 38 decrypts the encrypted visual data forming the visual data within the decryption integrated circuit 38.

In order to pass the visual data from the decryption integrated circuit 38 to the display integrated circuit 40, the decryption integrated circuit 38 encodes the visual data forming encoded visual data. The decryption integrated circuit transfers the encoded visual data to the driver circuit 42 of the display integrated circuit 40. The driver circuit 42 decodes the encoded visual data within the display integrated circuit 40. The encoded visual data is encrypted such that the visual data is not available as in-the-clear data within the display apparatus 26. Thus, a zealous technician will be unable to easily access an electronic form of the visual data within the display apparatus 26.

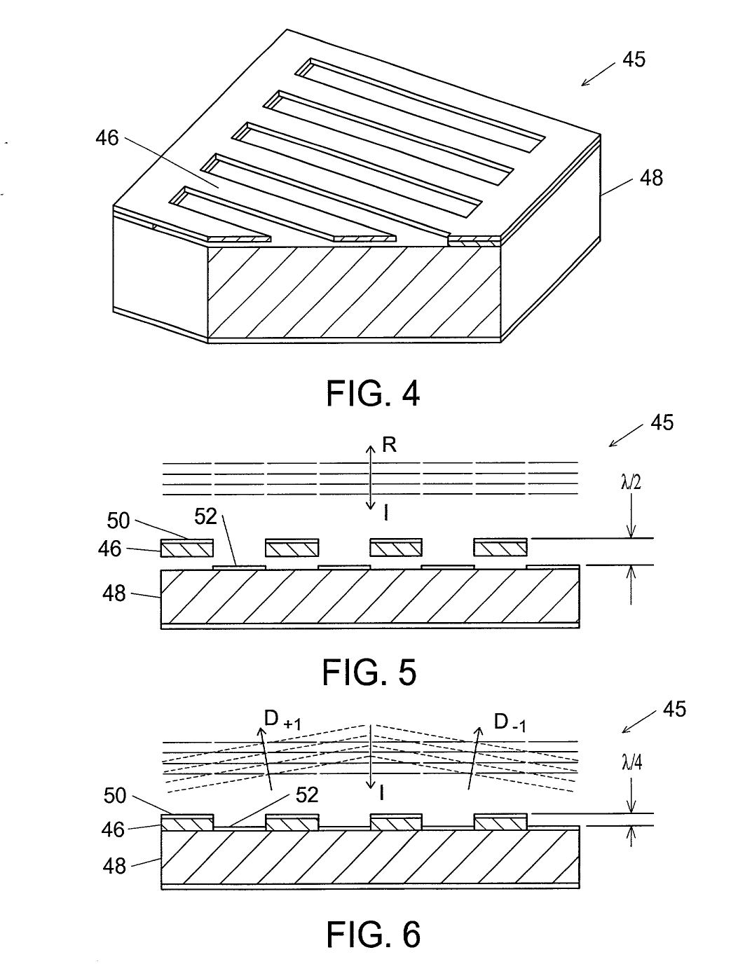

An alternative GLV of the present invention is disclosed in U.S. Pat. No. 5,311,360, which is hereby incorporated by reference. A portion of the alternative GLV is illustrated in FIG. 4. The alternative GLV 45 includes first ribbons 46 and a base 48. The first ribbons 46 are suspended in tension over the base 48.

A reflective state for the alternative GLV 45 is illustrated in FIG. 5. The first ribbons 46 include first reflective metallic coatings 50. The base 48 includes second reflective metallic coatings 52. In the reflective state, the first reflective metallic coatings 50 are located at a half wavelength λ/2 above the second reflective metallic coatings 52. Incident light I reflects from the first and second reflective coatings, 50 and 52, to form reflected light R. Since the first and second reflective coatings, 50 and 52, are separated by the half wavelength λ/2, a first phase shift for the incident light I reflecting from the first and second reflective metallic coatings, 50 and 52, is a full wavelength λ and thus the reflected light R is formed.

A diffractive state for the alternative GLV 45 is illustrated in FIG. 6. An electrostatic potential is developed between the first reflective metallic coatings 50 and the base 48, which deflects the first ribbons 46 to the base 48. In the diffractive state, the first reflective metallic coatings 50 are located at a quarter wavelength λ/4 above the second reflective metallic coatings 52. The incident light I reflects from the first and second reflective metallic coatings, 50 and 52, to form the diffractive state including plus and minus one diffraction orders, D₊₁ and D₋₁. Since the first and second reflective metallic coatings, 50 and 52, are separated by the quarter wavelength λ/4, a second phase shift for the incident light I reflecting from the first and second reflective metallic coatings, 50 and 52, is the half wavelength λ/2 and thus the diffractive state is formed.

The preferred GLV 44 of the present invention as well as a method of making the preferred GLV is disclosed in U.S. application Ser. No. 09/104,159, which is hereby incorporated by reference.

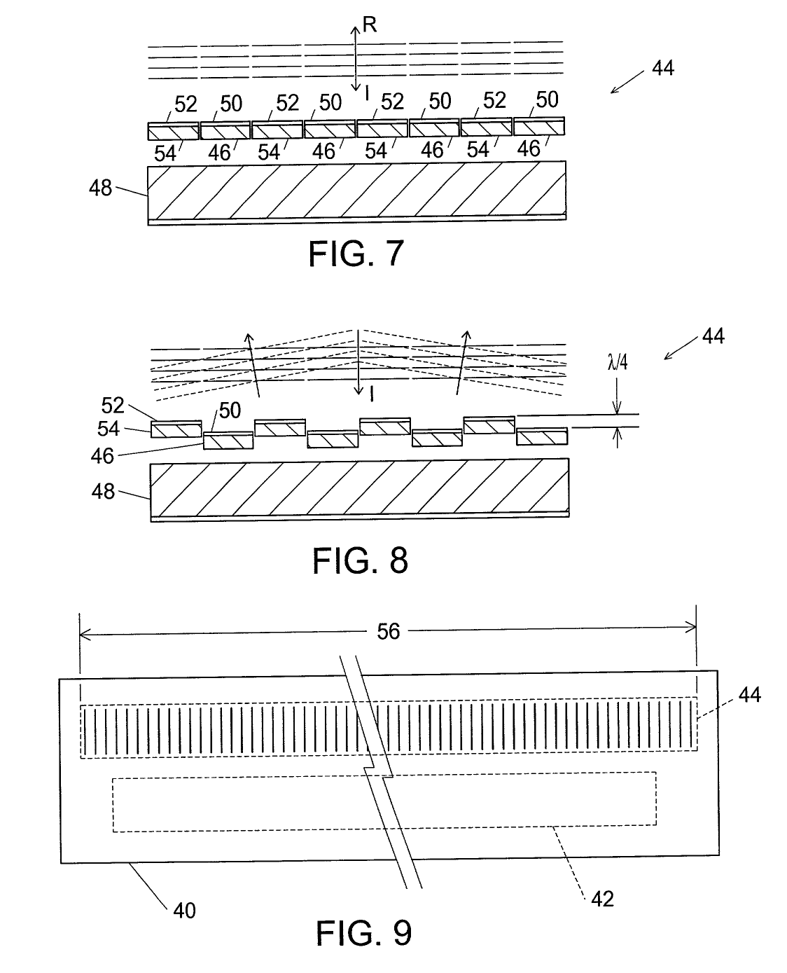

The reflective state for the preferred GLV 44 is illustrated in FIG. 7. The preferred GLV 44 includes the first ribbons 46, second ribbons 54, and the base 48. The first ribbons 46 include the first reflective metallic coatings 50. The second ribbons 54 includes the second reflective metallic coatings 52. In the reflective state, the first and second ribbons, 46 and 54, are suspended in tension at the same height above the base 48. The incident light I reflects from the first and second reflective metallic coatings, 50 and 52, to form the reflected light R. Since the first and second reflective metallic coatings, 50 and 52, are at the same height, a third phase shift for the incident light I reflecting from the first and second reflective metallic coatings is zero and thus the reflected light R is formed.

The diffractive state for the preferred GLV of the present invention is illustrated in FIG. 8. In the diffractive state, the electrostatic potential is developed between the first reflective coatings 50 and the base 48, which deflects the first ribbons 46 towards the base 48. The second ribbons 54 remain suspended in the tension above the base 48. In the diffractive state, a height difference between the first and second reflective metallic coatings, 50 and 52, is the quarter wavelength λ/4. The incident light I reflects from the first and second reflective coatings, 50 and 52, to form the diffractive state including the plus and minus one diffraction orders, D₊₁ and D₋₁. Since the first and second reflective metallic coatings, 50 and 52, are separated by the quarter wavelength λ/4, a third phase shift for the incident light is the half wavelength λ/2 and thus the diffractive state is formed.

In both the preferred GLV 44 and the alternative GLV 45, a pixel of a visual image is formed from a grouping of the first and second reflective metallic coatings, 50 and 52. Preferably, the pixel of the visual image is formed by three pairs of the first and second reflective metallic coatings, 50 and 52. In both the preferred GLV 44 and the alternative GLV 45, the first and second reflective metallic coatings, 50 and 52, are preferably aluminum.

It will be readily apparent to one skilled in the art that the quarter, half, and full wavelengths, λ/4, λ/2, and λ, of FIGS. 6, 7, and 9, are optical path lengths. Thus, adjusting an angle of incidence from normal to into or out-of the page will result in physical dimensions that are less than the quarter, half, and full wavelengths, λ/4, λ/2, and λ.

The display integrated circuit 40 of the present invention is illustrated in FIG. 9. The display integrated circuit 40 includes the driver circuit 42 and the preferred GLV 44. Preferably, the preferred GLV 44 includes one thousand eighty pixels 56. The one thousand eighty pixels 56 forms a vertical dimension of the visual image. The driver circuit 42 is illustrated on a front surface of the display integrated circuit. Alternatively, the driver circuit 42 is on a back surface opposite the front surface or is situated in an intermediary region between the front and back surfaces. The driver circuit is fabricated using known semiconductor processing techniques for fabricating integrated circuits. Since the driver circuit 42 and the preferred GLV 44 are integrated on the display integrated circuit, human access to the electronic version of the visual data within the display integrated circuit is not feasible.

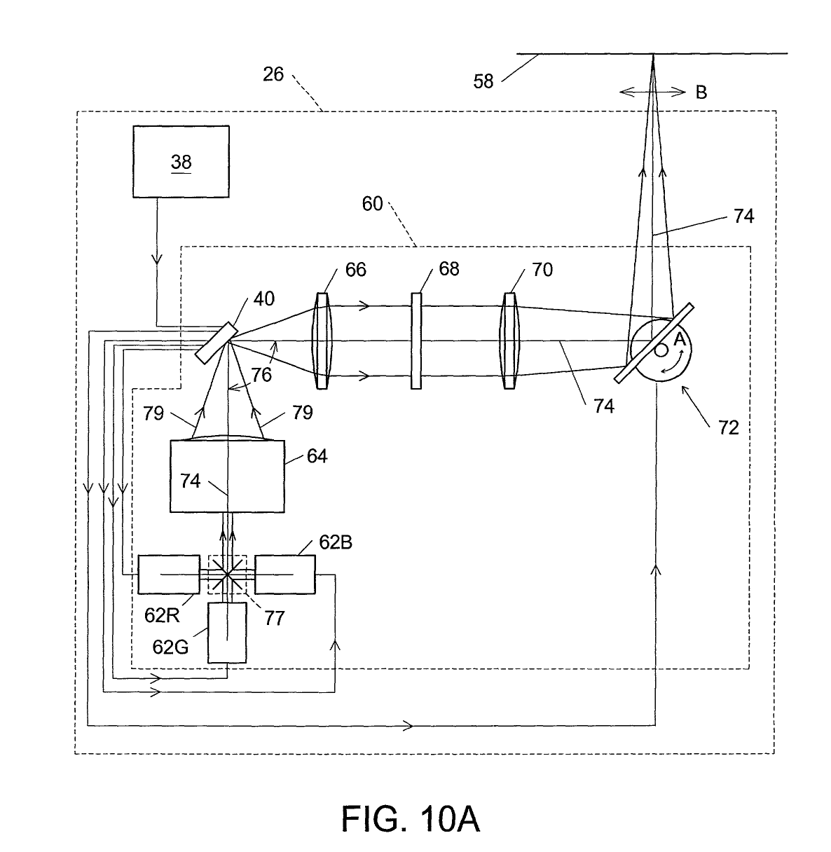

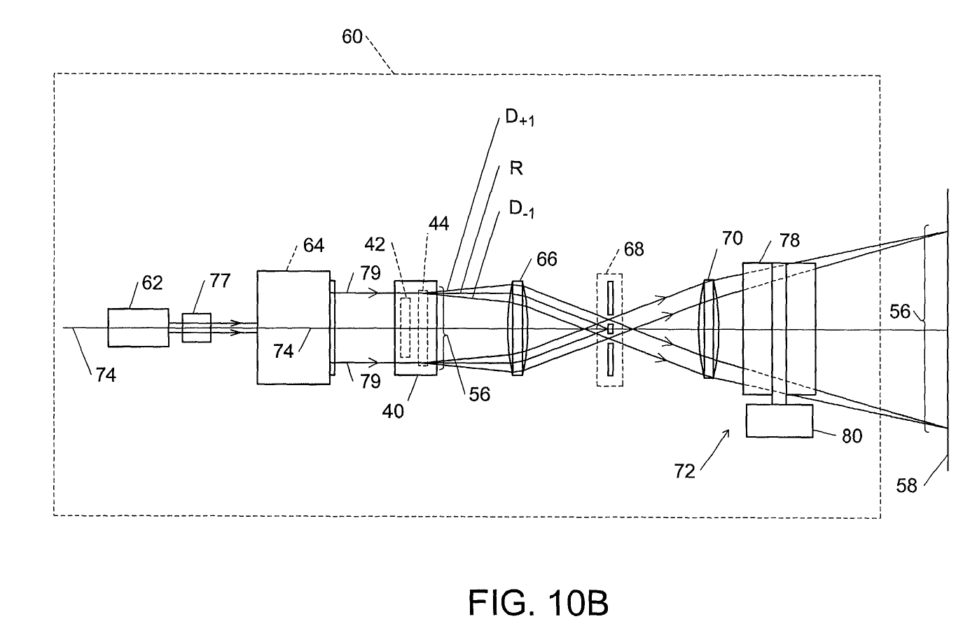

A plan view of the display apparatus 26 of the present invention is illustrated in FIG. 10A. The plan view also includes a viewing screen 58. The display apparatus 26 includes the decryption integrated circuit 38 and an optical system 60. The optical system 60 includes red, green and blue lasers, 62R, 62G, and 62B, a compound lens 64, the display integrated circuit 40, an eyepiece type lens 66, a stop 68, a projection lens 70, and a scanning mirror assembly 72. The optical system 60 is arranged along an optic axis 74. Note that as illustrated in FIG. 10A, an angle 76 for the optic axis 74 at the display integrated circuit 40 is a right angle. The angle 76 is for illustration purposes and is preferably much less than the right angle.

An unfolded elevation view of the optical system 60 of the display apparatus 26 and the viewing screen 58 is illustrated in FIG. 10B. The optical system 60 has been unfolded along the optic axis 74 for illustration purposes. Also, the red, green, and blue lasers, 62R, 62G, and 62B, are illustrated as a single laser 62.

In operation, the red, green, and blue lasers, 62R, 62G, and 62B, are sequentially activated in order to sequentially illuminate the GLV 44. Light from the red, green, and blue lasers, 62R, 62B, and 62G, are combined by a dichroic prism block 77. The compound lens 64 forms wedge focused light 79 that illuminates the GLV 44. The GLV 44 forms the reflected light R or the plus and minus one diffraction orders, D₊₁ and D₋₁, for each of the one thousand eighty pixels 56. The eyepiece type lens 66 focuses the reflected light R and the plus and minus one diffraction orders, D₊₁ and D₋₁. The stop 68 stops the reflected light R. The stop 68 allows the plus and minus one diffraction orders, D₊₁ and D₋₁, to pass the stop 68. The projection lens 70, via a scanning mirror 78 of the scanning mirror assembly 72, projects the one thousand eighty pixels 56 onto the viewing screen 58. The scanning mirror 78 is rotated in a first scan motion A by a scanning motor 80.

The decryption integrated circuit 38 receives the encrypted visual data and decrypts the encrypted visual data thus forming the visual data within the decryption integrated circuit 38. The decryption integrated circuit 38 encodes the visual data thus forming the encoded visual data. The decryption integrated circuit 38 transmits the encoded visual data to the driver circuit 42 of the display integrated circuit 40. The driver circuit 42 decodes the encoded visual data within the display integrated circuit 40 thus forming the visual data within the display integrated circuit 40.

The driver circuit 42 is coupled to the preferred GLV 44, the red, green, and blue lasers, 62R, 62G, and 62B, and the scanning mirror assembly 72. The one thousand eighty pixels 56 of the GLV are driven by the driver circuit 40 in order to form a linear image, which is projected onto the viewing screen 58. Thus, the one thousand eighty pixels 56 are projected onto the viewing screen 58, which forms the linear image on the viewing screen 58.

The linear image is formed by the red, green, and blue lasers, 62R, 62G, and 62B, being activated sequentially, which is referred to as a line sequential color. The linear image is formed by a red linear image of red pixels, a green linear image of green pixels, and a blue linear image of blue pixels projected on the viewing screen 58 using the line sequential color. Thus, the red, green, and blue pixels form color pixels and the color pixels form the linear image. The red, green, and blue linear images are projected onto the viewing screen 58 within a short time period so that a viewer viewing the visual image cannot detect the line sequential color. The line sequential color is repeatedly scanned over the viewing screen 58, with a second scan motion B, in order to form the visual image.

Frame formats that are likely to be used in electronic cinema applications include an Academy frame format and a CinemaScope frame format. For the Academy frame format, approximately 2,000 linear images are formed on the viewing screen 58. For the CinemaScope frame format, approximately 2,540 linear images are formed on the viewing screen 58. So for the Academy frame format, the visual image is formed by approximately a 2,000 by 1,080 of the color pixels. For the CinemaScope frame format, the visual image is formed by approximately a 2,540 by 1,080 of the color pixels.

It will be readily apparent to one skilled in the art that other arrays of the color pixels, with a different frame width or a different frame height, can form the visual image.

By appropriately choosing a speed for the first scan motion A, the scan motion B will be such that a video camera will be unable to record the visual image, which adds an additional level of security to the present invention.

In a first alternative electronic cinema system, the data network 24 is replaced by a storage media, which is physically carried from the encryption apparatus 22 to the display apparatus 26. The storage media is selected from a group including a magnetic tape, a magnetic disk, an optical disk, and a programmable memory device. The storage media is either a standard storage media or a non-standard storage media. The non-standard storage media is specifically designed to be compatible only with the display apparatus 26.

In a second alternative electronic cinema system, the asymmetric encryption method is replaced with a symmetric encryption method. The symmetric encryption method uses a secret key to encrypt the visual data. The symmetric encryption method uses the secret key to decrypt the encrypted visual data.

A first alternative asymmetric key method of the present invention includes the key production step 30 of the preferred asymmetric key method plus a private key output step, and private key input step. In the private key input step, the private key is input to the display apparatus 26 in a way that preferably precludes human access to the private key. Preferably, the first alternative asymmetric key method 28 and the private key input step are performed at a manufacturing facility for the display apparatus 26. In this way, the private key is input directly to the display apparatus 26 without human access. Alternatively, the private key input step includes placing the private key on a private key storage media. The private key is stored on the private key storage media in such a way that the private key can only be accessed once. Thus, the private key storage media is connected to the display apparatus 26 and the private key is transferred to the display apparatus 26 while the private key is erased from the private key storage media.

In first alternative display electronics, the decryption integrated circuit 38 and the display integrated circuit 40 are integrated circuit elements of a single integrated circuit. In the first alternative display apparatus, the decryption apparatus 38 does not encode the visual data nor does the driver integrated circuit 40 decode the encoded visual data. Since the decryption integrated circuit 38 and the display integrated circuit 40 are the integrated circuit elements of the single integrated circuit, the visual data can pass freely between the decryption integrated circuit 38 and the display integrated circuit 40 without providing the in-the-clear data.

A first alternative display apparatus of the present invention comprises an alternative optical system. The alternative optical system includes the red, green, and blue lasers, 62R, 62G, and 62B, first, second, and third compound optics, first, second, and third display integrated circuits, combining optics, the eyepiece type lens 66, the stop 68, the projection lens 70, and the scanning mirror assembly 72. In operation, the first alternative display apparatus illuminates the display screen 58.

In the first alternative display apparatus, the first display integrated circuit includes a red GLV, the second display integrated circuit includes a green GLV, and the third display integrated circuit includes a blue GLV. In operation, the red, green, and blue GLV's produce red, green, and blue linear images, respectively, which combine to form a color linear image. Thus, the first alternative display apparatus provides separate red, green, and blue channels, which combine simultaneously to illuminate the display screen 58.

In a second alternative display apparatus, a turning mirror arrangement is used to illuminate the GLV 44. Details of using the turning mirror are disclosed in related U.S. Pat. No. 5,982,553, entitled, “Display Device Incorporating One-Dimensional Grating Light Valve Array,” and U.S. Pat. No. 5,629,801, entitled, “Diffraction Grating Light Doubling Collection System,” which are incorporated in their entirety by reference.

In a third alternative display apparatus, the red, green, and blue lasers, 62R, 62G, and 62B, are replaced with red, green, and blue light emitting diodes or other red, green, and blue light sources.

In a fourth alternative display apparatus, the red, green, and blue lasers, 62R, 62B, and 62G, are replaced by a monochrome light source so that a monochrome image is formed on the viewing screen.

It will be readily apparent to one skilled in the art that, while this description is directed towards electronic cinema, the method, system, and display apparatus of the present invention are appropriate for providing a securely transmitted and displayed visual image in applications such as cable television, direct satellite television, securely broadcast television, video telephone, etc.

It will be readily apparent to one skilled in the art that other various modifications may be made to the preferred embodiment without departing from the spirit and scope of the invention as defined by the appended claims.

We claim:

1. A method of securely displaying visual data comprising the steps of:
a. encrypting the visual data, whereby encrypted visual data is formed;
b. transporting the encrypted visual data to a display apparatus;
c. decrypting the encrypted visual data within the display apparatus such that an electronic version of the visual data is maintained within circuit elements that are substantially inaccessible; and
d. displaying the visual data as a visual image.

2. The method of claim 1 wherein the circuit elements comprise integrated circuit elements.

3. The method of claim 2 wherein the integrated circuit elements comprise a display circuit and a diffractive light valve, the diffractive light valve displaying the visual image.

4. The method of claim 3 wherein the diffractive light valve comprises a grating light valve.

5. The method of claim 4 wherein the integrated circuit elements comprise portions of a single integrated circuit.

6. The method of claim 4:
a. wherein the integrated circuit elements comprise individual integrated circuits; and
b. further comprising the steps of encoding and decoding the visual data in order to transfer the visual data between the individual integrated circuits.

7. The method of claim 4 wherein the display circuit comprises a driver circuit for driving the grating light valve.

8. The method of claim 4 wherein the step of displaying the visual data comprises scanning a line image over a display screen such that the visual image has low persistence.

9. The method of claim 4 wherein the integrated circuit elements comprise a decryption circuit.

10. The method of claim 4 wherein the step of transporting the encrypted visual data comprises electronic transmission.

11. The method of claim 10 wherein the electronic transmission is selected from the group consisting of satellite transmission, optical fiber transmission, and internet transmission.

12. The method of claim 4 wherein the step of transporting the encrypted visual data comprises recording the encrypted visual data on a storage media and physically transporting the storage media.

13. The method of claim 12 wherein the storage media comprises a standard storage media.

14. The method of claim 12 wherein the storage media comprises a nonstandard storage media.

15. The method of claim 1:
a. wherein the step of encrypting the visual data comprises uses a public key; and
b. further comprising the step of generating the public key and a private key, the private key residing within the display apparatus.

16. The method of claim 15 wherein the step of generating the public key and the private key takes place within the display apparatus.

17. The method of claim 15
a. wherein the step of generating the public key and the private key takes place outside of the display apparatus; and
b. further comprising the step of inputting the private key to the display apparatus in such a manner that human access to the private key is substantially unavailable.

18. The method of claim 1 wherein the step of encrypting the visual data includes using a secret key and further wherein the step of decrypting the encrypted visual data includes using the secret key.

19. A system for securely transmitting and displaying visual data comprising:
a. an encryption apparatus for encrypting the visual data, whereby encrypted visual data is formed;
b. means for transporting the encrypted visual data from the encryption apparatus to a display facility; and
c. a display apparatus located at the display facility that receives the encrypted visual data, the display apparatus decrypting the encrypted visual data such that an electronic version of the visual data is maintained within circuit elements that are substantially inaccessible, the display apparatus displaying the visual data as a visual image.

20. The system of claim 19 wherein the circuit elements comprise integrated circuit elements.

21. The system of claim 20 wherein the integrated circuit elements comprise a display circuit and further wherein the display circuit comprises a diffractive light valve for displaying the visual image.

22. The system of claim 21 wherein the light valve comprises a grating light valve.

23. The system of claim 22 wherein the integrated circuit elements comprise portions of a single integrated circuit.

24. The system of claim 22 wherein the integrated circuit elements comprise individual integrated circuits and further wherein the integrated circuit elements encode and decode the visual data to transfer the visual data between the individual integrated circuits.

25. The system of claim 22 wherein the display apparatus includes a scanning device for scanning a linear image over a display screen such that the visual image has low persistence.

26. The system of claim 22 wherein the means for transporting the encrypted visual data includes means for electronic transmission.

27. The system of claim 26 wherein the means for electronic transmission is selected from the group consisting of satellite transmission, optical fiber transmission, and internet transmission.

28. The system of claim 22 wherein the means for transporting the encrypted visual data includes a storage media, the storage media holding the encrypted visual data during transport of the storage media.

29. The system of claim 28 wherein the storage media comprises a standard storage media.

30. The system of claim 28 wherein the storage media comprises a non-standard storage media.

31. The system of claim 19 wherein the encryption apparatus uses a public key for encrypting the visual data and further wherein the display apparatus uses a private key for decrypting the visual data, the private key residing within the display apparatus.

32. The system of claim 31 wherein the display apparatus generates the public key and the private key.

33. The system of claim 31 wherein the public key and the private key have been generated outside of the display apparatus and further wherein the private key has been generated and input to the display apparatus in such a manner that human access to the private key is substantially unavailable.

34. The system of claim 19 wherein the encryption apparatus uses a secret key for encrypting the visual data and further wherein the display apparatus uses the secret key for decrypting the visual data.

35. A display apparatus for displaying encrypted visual data comprising circuit elements that are substantially inaccessible, the circuit elements comprising a decryption circuit for decrypting the encrypted visual data, whereby visual data is formed, the circuit elements comprising a display circuit for displaying the visual data as a visual image, such that an electronic version of the visual data is maintained within the circuit elements.

36. The display apparatus of claim 35 wherein the display circuit comprises a diffractive light valve for displaying the visual image.

37. The display apparatus of claim 36 wherein the diffractive light valve is a grating light valve.

38. A display apparatus for displaying encrypted visual data comprising:
a. a decryption circuit for decrypting the encrypted visual data, whereby visual data is formed; and
b. a grating light valve for displaying the visual data as a visual image.
